(19) United States
(12) Patent Application Publication
(10) Pub. No.: US 2025/0373521 A1
(43) Pub. Date: Dec. 4, 2025

(54) Method for delivering information, selecting method, and entities configured to implement these methods

(71) Applicant: ORANGE, ISSY LES MOULINEAUX (FR)

(72) Inventors: Philippe Tamagnan, Chatillon (FR); Antoine Mouquet, Chatillon (FR)

(21) Appl. No.: 18/876,386

(22) PCT Filed: Jun. 15, 2023
(86) PCT No.: PCT/EP2023/066059

§ 371 Date: Dec. 18, 2024

(30) Foreign Application Priority Data
Jun. 20, 2022 (FR) FR2206044

(51) Int. Cl. H04L 41/50; H04L 41/5051; H04W 60/00

(52) U.S. Cl. CPC H04L 41/5058; H04L 41/5051; H04W 60/00

(57) ABSTRACT

A method for delivering information relating to a first device of a communication network, the first device hosting a network function implementing at least one functionality in the network in a service area covering at least one zone that is referred to as an elementary zone. The method includes obtaining, for at least one elementary zone covered by the service area of the first device, a weight assigned to this elementary zone, the weight being a real number higher than or equal to 0; and delivering, to a second device of the network, all or some of the weights obtained.

### CROSS-REFERENCE TO RELATED APPLICATIONS

This Application is a Section 371 National Stage Application of International Application No. PCT/EP2023/066059, filed Jun. 15, 2023, and published as WO 2023/247303 A1 on Dec. 28, 2023, not in English, which claims priority to and the benefit of French Patent Application No. 2206044, filed Jun. 20, 2022, the contents of which are incorporated herein by reference in their entireties.

### FIELD OF THE DISCLOSURE

The disclosure belongs to the general field of telecommunications.

It more specifically relates to the management of devices implementing various functionalities or services in a communication network, such as, for example, in a 5G Core network (or “5GC”) as defined by the 3GPP standard. Such devices in this context are, for example, devices hosting Network Functions (or “NF”) implementing functionalities such as network access, the mobility of the users or else the management of the sessions established in the network, the storage and publication of the profiles of the network functions, etc. Several instances of the same network function can be deployed within a 5G core network, with each instance being able to be responsible for serving a given geographical sector, referred to herein as “service area”, formed by a group of radio cells, for example.

### BACKGROUND OF THE DISCLOSURE

In order to optimize the procedures within the 5G core network, the NF functions can use a specific NF function responsible for collecting and analyzing network data, referred to as the NWDAF (“NetWork Data Analytics Function”) function. The NWDAF function offers the NF functions of the network using said NWDAF function, statistical analyses and/or predictions concerning the behavior of the network, notably in terms of quality of service, and/or concerning the behavior of the user equipment (or UE). The predictions can be global, i.e., can be established at the level of the network, of a server, of an application or else of a region (for example, network resource load rate, average quality of service, number of users connected to the network or number of active sessions, etc.), or can be individual, i.e., can relate to a UE or to a particular group of UEs (for example, future location of a UE, volume of a future communication session of a UE, etc.). The statistical analyses and the predictions are carried out based on information that the NWDAF function collects from other NF functions of the network and/or from nodes of the radio access network via the network management entity responsible for operations, administration and maintenance, also known as OAM entity (“Operations, Administration and Maintenance”).

As mentioned above, several NWDAF instances can be deployed within the 5G core network, with each being responsible for serving a specific geographical service area. When an NF function of the network (for example, an AMF function (Access and Mobility management Function)) wishes to access the functionalities implemented by an NWDAF function, in accordance with the 3GPP standard, it polls the Network Repository Function (NRF). This NRF function in a known manner maintains a “catalogue” of the profiles of the instances of the NF functions of the 5G core network, with each profile associated with an instance of an NF function containing miscellaneous information such as the identity of the instance, the type of NF function implemented by the instance, its service features, its service area, etc.

Thus, when a “consumer” NF function wishes to access the functionalities offered by another NF function, called “provider” function, the “consumer” NF function sends a discovery request to the NRF function specifying one or more search criteria characterizing the “provider” NF function it wishes to communicate with, Such a search criterion notably can be the desired type of NF function, i.e., NWDAF in the aforementioned example, the desired type of statistics and/or predictions, an area of interest served by the desired NF function, etc. The NRF function, based on the NF function profiles available thereto, then responds to the discovery request by identifying one or more instances, called “candidate” instances, meeting the one or more search criteria specified in the discovery request: if several candidate instances are identified, the consumer NF function must then select one that meets their requirements.

The procedure for selecting an NWDAF network function instance (referred to hereafter as “NWDAF instance” for the sake of simplification) by a consumer NF function is described in the 3GPP TS 23.288 document, entitled “Architecture Enhancements for 5G system (5GS) to support network data analytics services (Release 17)”, V17.4.0, March 2022, paragraph 5.2. This procedure prescribes selecting an NWDAF instance, the service area of which encompasses an area of interest defined by the consumer NF function using, for example, identifiers of the TAI (“Tracking Area Identity”) type broadcast by the cells present in this area of interest. Such an area of interest is, by way of an illustration, the area where a UE is located, for which UE the consumer NF function wishes to receive statistical analyses and/or predictions from the NWDAF function.

If this is not possible (for example, the TAIs of the area of interest are not known to the consumer NF function, the area of interest is not completely covered by a service area), then it is worthwhile selecting an NWDAF instance with an aggregation capability (i.e., which is capable of collecting and aggregating the statistical analyses and the predictions provided by several other NWDAF instances) covering the widest possible geographical area.

The selection procedure defined in document TS 23.288 nevertheless does not provide any indication for selecting an NWDAF instance when the area of interest of the consumer NF function is covered by the service areas of several distinct candidate NWDAF instances. FIG. 1 illustrates such a situation.

In this figure, four service areas Z1, Z2, Z3 and Z4 are respectively assigned to four NWDAF candidate instances, referenced NWDAF1, NWDAF2, NWDAF3 and NWDAF4. A consumer NF function NF1 wishing to acquire predictions relating to a user equipment UE1 is considered; the function NF1 thus defines the area in which the user equipment UE1 is located as the area of interest ZI. In the example illustrated in FIG. 1, this area of interest ZI is located in the service areas Z1, Z2 and Z4 of the candidate instances NWDAF1, NWDAF2 and NWDAF4. According to the selection procedure mentioned in document TS 23.288, the “consumer” function NF1 can equally select any one of the candidate instances NWDAF1, NWDAF2 and NWDAF4 for sending its requests for predictions relating to the user equipment UE1.

However, it should be noted that the user equipment UE1 is located at the edge of the service areas of the candidate instances NWDAF1 and NWDAF4. If the user equipment UE1 moves and exits any of these service areas, this only leaves a short amount of time for the corresponding NWDAF instance to collect data concerning the user equipment UE1 in order to produce the predictions requested therefrom by the consumer function NF1. It is thus easy to understand that selecting the candidate instance NWDAF2, rather than the candidate instances NWDAF1 and NWDAF4, is more appropriate in this context.

A similar situation can occur when, during the data collection and/or analytical computation period, an NWDAF instance (hereafter called “source” NWDAF instance) selected by a consumer NF function is required to transfer all or some of its statistical analysis and/or prediction subscriptions to another NWDAF instance (hereafter called “target” NWDAF instance). The reason for such a transfer can be internal (for example, load balancing, progressive shutdown of the source NWDAF instance, etc.) or external (for example, mobility of the user equipment targeted by the statistical analyses and/or predictions requested by the consumer NF function). This transfer procedure is described in document TS 23.288, paragraph 6.1B. The transfer to the target NWDAF instance can be preceded by a prior preparation phase for initiating data collection on the target NWDAF instance before the source NWDAF instance is no longer effective (for example, before the user equipment UE1 subject to the statistical analyses and/or predictions requested by the consumer NF function exits the service area of the source NWDAF instance). However, document TS 23.288 does not provide any indication concerning the initiating event for this prior preparation phase.

The transfer procedure can be initiated by the source NWDAF instance, which must then select the target NWDAF instance that will act as a relay for it in order to establish the statistical analyses and/or predictions requested by the consumer NF function. The discovery of the candidate NWDAF instances for the transfer by the source NWDAF instance is carried out by sending a discovery request to the NRF function, as described above, and the selection of an NWDAF instance from among the candidate NWDAF instances identified by the NRF function is carried out according to the selection procedure defined in paragraph 5.2 of document TS 23.288. The source NWDAF instance is therefore likely to encounter the same previously mentioned selection problems when several service areas assigned to distinct candidate NWDAF instances cover the area of interest defined by the source NWDAF instance.

### SUMMARY

The invention overcomes the aforementioned disadvantages by proposing a method for delivering information relating to a first device of a communication network, with this first device hosting a network function implementing at least one functionality in the network in a service area covering at least one area, called elementary area, this method comprising:
a step of acquiring, for at least one elementary area covered by the service area of the first device, a weight assigned to this elementary area, with this weight being a real number greater than or equal to 0; and
a step of delivering all or some of the weights acquired during the acquisition step to a second network device.

Correspondingly, the invention also relates to an entity, called delivery entity, of a communication network, configured to deliver information relating to a first device of the network, with the first device hosting a network function implementing at least one functionality in the network in a service area covering at least one area, called elementary area. The delivery entity comprises:
an acquisition module, configured to acquire, for at least one elementary area covered by the service area of the first device, a weight assigned to this elementary area, with this weight being a real number greater than or equal to 0; and
a delivery module, configured to deliver all or some of the weights acquired by the acquisition module to a second network device.

The delivery entity can be the first device or another device of the network. The first device is typically a service provider device or a provider device hosting a network function. For example, the first device can host a network function for collecting and analyzing network data; in the specific context of a 5G network, such a first device is a device hosting an NWDAF network function.

The second device is typically a service consumer device or a network consumer device wishing to access the services and/or functionalities proposed by the first device. Such a consumer device is, for example, a device hosting an AMF network function wishing to acquire statistics and/or predictions of a device hosting an NWDAF network function. However, it can be a device other than a consumer device, such as, for example, a device configured to manage the devices hosting the various network functions, and notably to maintain and publish the profiles of these devices. Within the context of a 5G network mentioned above, such a device is typically a device hosting an NRF network function.

Thus, the invention has a preferred but non-limiting application in the following two contexts:
the first device is an NWDAF network function implementing the delivery method (thus integrating a delivery entity within the meaning of the invention), and the second device that the first device delivers the weights to is an NRF network function;
the first device is an NWDAF network function, the delivery method is implemented by an NRF network function (which then integrates a delivery entity within the meaning of the invention), and the second device is a network function asking the NRF network function (for example, an AMF network function or an NWDAF network function) to select an NWDAF network function in order to establish predictions and/or statistics or to transfer subscriptions relating to such predictions and/or statistics.

Of course, these examples are provided solely by way of an illustration. It should be noted that, even though it has been introduced with reference to devices hosting NRF, NWDAF and AMF network functions in a 5G core network, the invention can be applied in other contexts, and notably to other functionalities of the network, as well as to other networks (for example, 6G network, proprietary network, etc.). The invention has a preferred application as soon as a selection is necessary from among several devices hosting the same network function within a network and serving service areas covering a given area of interest, in other words overlapping (i.e., having an intersection) at least in the vicinity of the area of interest.

In order to manage such a situation and allow selection of the device with the most suitable coverage in order to provide a given network function, the invention advantageously uses a new way of describing the service areas assigned to devices hosting network functions, geographically distributed throughout the network. More specifically, the invention exploits the fact that, in a network, a service area assigned to such a device generally covers an integer number, greater than or equal to 1, of “elementary” areas, and thus proposes describing each service area based on the elementary areas covered thereby, to which a weight is assigned, with this weight being intended to be taken into account when the device in question competes with other network devices to implement the functionalities of a certain network function. It is possible, for example, to contemplate assigning a weight at least to each elementary area covered by the service area of the first device and by at least one other service area of at least one third network device, with this third device notably being able to host the same network function as the first device. According to another example, a weight is assigned to each elementary area of each service area.

Such an elementary area is typically a “unitary” geographical area associated with the network and defined for the deployment and/or operational functioning needs of the network. For example, for a cellular network, an elementary area can correspond to a cell of the network or to a set made up of one or more cells of the network, such as a location area (more commonly known as TA or “Tracking Area”). Such elementary areas advantageously form, as a whole, a mosaic of the entire geographical coverage area of the network. Since the service areas of the network devices are conventionally defined based on such elementary areas, this means that it is possible to adapt to the topology of the network and to its deployment (it should be noted, moreover, that the dimensions of the elementary areas can differ from one geographical area to another according to the deployment conditions of the network; for example, larger or smaller cells can be contemplated depending on whether an urban environment or a rural environment is involved), and/or to its operational functioning.

Furthermore, a good compromise is ensured between complexity and precision when implementing the invention: such elementary areas actually generally represent the level of granularity that is considered when executing most of the operational mechanisms for operating the network; furthermore, it is the identifiers of these elementary areas that are conveyed in the signaling messages.

As a variant, it is possible to contemplate elementary areas that strictly speaking are independent of the network, for example, geographical areas with fixed dimensions (for example, 10 km×10 km squares) forming a mosaic of the coverage area of the network.

Such a variant notably can be contemplated within a context of selecting an entity of the network for ensuring air control of flying objects such as drones. Such an entity is, for example, within the context of a 5G network, a USS/UTM (“UAS Service Supplier/UAS Traffic Management”, with UAS denoting “Uncrewed Aircraft System”) function.

When the same elementary area is covered by service areas assigned to distinct devices hosting the same network function (NWDAF network function in the situation illustrated in FIG. 1), a different weight can be assigned to this elementary area for the various relevant service areas. This allows different priorities to be assigned to the devices covering these common elementary areas (reflecting, for example, the preferences of the network operator), and thus facilitates the selection of one device from among the other devices based on these priorities. Conversely, when not intending to establish priority between two devices implementing the same network function, the same weight can be assigned to the elementary area for the service areas of these two devices.

However, this is only a particular implementation choice, and other assignment policies can be contemplated. The invention offers considerable flexibility in this respect, notably allowing the preferences of the operator to be easily reflected.

In general, the weights are assigned to the elementary areas according to a strategy that is consistent with the selection policy intended (for example, by the network operator) to be implemented in the network, taking into account the functionalities implemented by the devices and the considered context.

By way of an illustration, in the example contemplated above, when intending to take into account the mobility of a user equipment within a context of selecting an NWDAF function instance that requires data collection over a fairly long time period, the weight assigned to an elementary area for the first device can depend on the distance from this elementary area to the center of the service area of the first device and/or its distance relative to the border (i.e., the edge) of this service area. Notably, the further the center of an elementary area is away from the center of the considered service area, or the closer this center is to the edge of the service area, the lower the weight assigned to this elementary area may be. Typically, if a service area is made up of a large number of cells arranged in a row, it can be advantageous to assign a lower weight to the cells located near the ends of the row (for example, at a distance d from the ends) relative to the other cells (without necessarily establishing a weight distinction for the cells located beyond the distance d, whether or not they are close to the center of the row). By proceeding thus, an elementary area is assigned a lower weight for the device whereby it is furthest from the center of the service area or closer to the limits of the service area.

Of course, this is only an illustrative example, and other assignment strategies can be applied. The selection of a particular strategy can depend on various factors, such as the application context of the invention, the topology of the network, the configuration of the service areas (for example, if a service area covers only one elementary area, or a plurality of elementary areas arranged in a row), the nature of the implemented network function, etc.

Furthermore, according to the application context of the invention, it is possible to allocate a relative weight to an elementary area (expressed in the form of a percentage, for example), ranging between 0 and 1, and optionally normalized over all the service areas covering this elementary area served by devices implementing the same network function, or to allocate an absolute weight, greater than or equal to 0. Assigning non-normalized absolute weights facilitates the management of an evolution in these weights, notably when deleting or adding an instance of a given network function, However, it is worthwhile ensuring that these weights are expressed according to the same scale (so that they remain comparable).

It should be noted that the weights can be statically assigned to the elementary areas covered by a service area of a device, for example, they can be empirically assigned by the network operator or by means of experts, and then acquired by means of a configuration implemented by the network operator by means of mechanisms that are per se known. As a variant, the assignment can be more dynamic, and the weights can be generated by executing a given algorithm or a particular analytical formula applied by the first device, for example.

Furthermore, it is possible to independently assign weights to the same elementary area for service areas of devices hosting various network functions. The assigned weights thus equally can be identical or different whenever they relate to service areas of devices providing different functionalities in the network.

As a variant, a corresponding assignment of the weights can be contemplated for some functionalities.

As emphasized above, the invention offers considerable flexibility in this respect according to the implementation policy and strategy adopted by the operator.

Irrespective of the implementation policy and choice adopted to assign the weights to the elementary areas covered by a service area of a device, these provide a valuable indication concerning the priority that the network grants to this device for implementing a given network function in an area of interest distributed over one or more elementary areas covered by the service area of the device. This allows an informed selection to be made, in a given context, concerning the best device in the network implementing a particular network function by comparing the weights assigned to the elementary areas for various devices hosting the same network function.

In order to make this selection, a metric can be evaluated, for example, based on the weights assigned to the elementary areas covering an area of interest for several devices hosting the same network function, and the device optimizing the metric thus evaluated can be selected. Such a metric is, for example, the sum (optionally weighted) of the weights assigned to the elementary areas covered by the area of interest. As a variant, other metrics can be contemplated for comparing the weights assigned for various devices with the elementary areas included in the area of interest.

In a particular embodiment, the second device is configured to manage devices hosting network functions and all or some of the acquired weights are delivered to the second device when registering or updating a profile of the first device at the second device. Such a second device is, for example, in a 5G core network, as mentioned above, a device hosting an NRF function, and maintaining profiles of the network function instances deployed in the network.

In another embodiment, the acquired weights assigned to the elementary areas covered by said service area are acquired when registering a profile of the first device and all or some of said acquired weights are delivered in response to a discovery request for discovering network devices hosting a network function and meeting at least one given search criterion, with said discovery request originating from the second device and said first device meeting said at least one given search criterion.

These two embodiments propose enriching the profiles of the devices maintained within the network (for example, by the NRF function for a 5G core network) and describing the features of the services/functionalities offered by these devices, with the elementary areas covered by the service areas served by these devices, and the weights assigned to these elementary areas. This makes this information easily accessible to the consumer devices consulting these profiles. The implementation of the invention is thus facilitated, notably within the context of a 5G network, since it is easily integrated into the registering, updating and discovery procedures that are already defined within such a network and does not require the definition of new structures and new procedures for storing or accessing this information.

As mentioned above, various strategies can be contemplated to assign a weight to an elementary area covered by a service area.

Thus, in a particular embodiment, when an elementary area is covered by the service area of the first device and at least one other service area of at least one third device of the network hosting the same network function as the first device, a different weight is assigned to said elementary area for the service area of the first device and for said at least one other service area of said at least one third device.

In addition, the weights assigned to this elementary area for the service area of the first device and for said at least one other service area of said at least one third device can be selected such that their sum is non-zero and is less than or equal to 1.

A sum that is taken as equal to 1 allows the weights to be normalized that are assigned to the same elementary area on overlapping service areas (i.e., which have a non-zero intersection or else are not disjoint) served by distinct devices. This normalization facilitates the interpretation of the metrics acquired for the various devices and the priorities reflected by these metrics.

However, it is possible to abstain from proceeding with such a normalization process whenever the weights allocated to the same elementary area for various devices are expressed in the same scale, which allows them to be compared with one another and a hierarchy (i.e., a preference) to be established, if applicable, between the devices.

In a particular embodiment, the delivery method further comprises:
a step of updating at least one weight assigned to one of said elementary areas covered by said service area of the first device; and
a step of delivering said at least one updated weight to the second device.

This embodiment allows a potential evolution over time of the weights assigned to the elementary areas to be taken into account and ensures that the second device is notified of this evolution. Such an evolution notably can be linked to the appearance or to the disappearance of network function instances in the network, but also can be linked to other factors (for example, balancing of the load, temporary unavailability of a network function instance, etc.).

In light of the above, the invention facilitates and therefore optimizes the selection of a device of the network from among several devices providing the same network function. Thus, according to another aspect, the aim of the invention is a selection method, by a device, called fourth device, of a communication network, comprising:
a step of sending a device of the network, called fifth device, a discovery request for discovering network devices hosting a network function and meeting at least one given search criterion;
a step of acquiring a response to said discovery request identifying at least one network device, called candidate device, hosting a network function and meeting said at least one given search criterion, with said response comprising, for each candidate device with a service area covering an area of interest defined by the fourth device, a weight assigned to each area, called elementary area, covered by said service area and said area of interest, said weight being a real number greater than or equal to 0; and
a step of selecting one of said candidate devices in order to implement at least one functionality of the network function that it hosts by comparing the weights assigned to the elementary areas covered by said area of interest acquired for each candidate device identified in the response.

Correspondingly, the invention also relates to an entity, called selection entity, of a communication network comprising:
a sending module, configured to send a network device a discovery request for discovering network devices hosting a network function and meeting at least one given search criterion;
an acquisition module, configured to acquire a response to said discovery request identifying at least one network device, called candidate device, hosting a network function and meeting said at least one given search criterion, with said response comprising, for each candidate device with a service area covering an area of interest defined by the selection entity, a weight assigned to each area, called elementary area, covered by said service area and said area of interest, said weight being a real number greater than or equal to 0; and
a selection module, configured to select one of said candidate devices in order to implement at least one functionality of the network function that it hosts, by comparing the weights assigned to the elementary areas covered by the area of interest that are acquired for each candidate device identified in the response.

The selection method and entity benefit from the same aforementioned advantages as the delivery method and entity according to the invention.

By way of an illustration, the fourth device can be a device hosting a consumer NF function, such as, for example, an AMF function, the fifth device can be a device hosting an NRF function, and the candidate devices can be devices hosting an NWDAF function. Of course, this example is provided solely by way of an illustration and does not limit the invention. Thus, according to another example, the fourth device can be a device hosting an NWDAF function and searching for another NWDAF function instance for transferring its subscriptions of predictions and/or statistics.

It should be noted that the first, second, third, fourth and fifth devices and the candidate devices do not necessarily designate distinct devices in pairs. For example, the fifth device within the meaning of the invention can be a second device within the meaning of the invention that has acquired the weights associated with the elementary areas of the network covered by the service areas of a plurality of first devices within the meaning of the invention, with the candidate devices identified by the fifth device being selected from among these first devices.

In a particular embodiment, the selection step comprises determining, for each candidate device of the network identified in the response, a metric based on the acquired weights assigned to the elementary areas covered by the service area of this candidate device and by the area of interest, with the selected candidate device being the candidate device that optimizes said metric from among the candidate devices identified in the response.

For example, the metric determined for one of said candidate devices corresponds to a weighted sum of the weights assigned to the elementary areas covered by the service area of this candidate device and by the area of interest defined by the fourth device.

The weighting factors used to evaluate the global metric are positive or zero real numbers, for example, rational numbers (for example, percentages) ranging between 0 and 1, or more generally real numbers ranging between 0 and 1.

According to a first variant, the weighting factors used in the weighted sum are all taken to be equal to 1. This amounts to considering the sum of the weights assigned to the elementary areas that are covered by the service area of the considered candidate device and by the area of interest as a metric.

According to a second variant, in the weighted sum, each weight assigned to an elementary area is weighted by a probability of the presence of a user equipment managed by the fourth device in this elementary area.

The probability of the presence of the user equipment can originate from a mobility prediction made, for example, by a device hosting a network data collection and analysis function, such as a device hosting an NWDAF function for a 5G network. As a variant, it can result from the observation of the presence of the user in the elementary area.

This second variant has a preferred application within the context of a transfer procedure, and more specifically when the fourth device is a device providing a certain functionality in the network in connection with a user equipment (for example, a device hosting an NWDAF network function) and it polls the fifth device (for example, a device hosting an NRF function) in order to identify a relay to which to transfer the subscriptions relating to the user equipment. The selected candidate device is then used as a relay of the fourth device in order to implement said functionality initially provided by the fourth device. Within such a context, the second variant ensures that the transfer to the relay thus selected is durable and does not require, in the immediate short term, the selection of a new relay device for managing the mobility of the user equipment, which could prove to be detrimental (it is indeed desirable, for the sake of minimizing network signaling and of greater reliability, for transfer procedures not to be initiated too often).

Thus, in a particular embodiment, the fourth device and said selected candidate device host the same network function, and said selected candidate device is used as a relay of the fourth device in order to implement at least one functionality of said network function.

As mentioned above, it is possible to contemplate initiating a preparatory phase, prior to the transfer procedure, to avoid a transfer that is too sudden and any back-and-forth between the fourth device and the selected candidate device serving as a relay. This preparatory phase advantageously uses the overlap of the service areas of the fourth device and of the relay device. During this preparatory phase, the candidate device selected as a relay carries out some operations that are necessary for the proper execution and the efficiency of the transfer: typically, for an NWDAF network function, during this preparatory phase the candidate device selected as a relay can begin to collect and analyze network data in connection with the subscriptions that will be transferred thereto. The invention, in a particular embodiment, advantageously provides indications concerning the appropriate time for initiating such a preparatory phase.

More specifically, in a particular embodiment, the selection method further comprises, when the fourth device detects the entry of a user equipment that it manages into an elementary area covered by its service area, and having an assigned weight for the fourth device that is less than a given threshold or is less than a weight assigned to said elementary area for one of said candidate devices identified in the response to the discovery request, initiating a phase of preparing the use of the selected candidate device as a relay of the fourth device.

This embodiment therefore advantageously notifies the fourth device when to initiate the preparatory phase of the transfer, which improves the efficiency of the transfer.

In a particular embodiment, the delivery and selection methods are implemented by a computer.

A further aim of the invention is a computer program on a storage medium, with this program being able to be implemented in a computer or more generally in a delivery entity according to the invention and comprising instructions adapted for implementing a delivery method as described above.

A further aim of the invention is a computer program on a storage medium, with this program being able to be implemented in a computer or more generally in a selection entity according to the invention and comprising instructions adapted for implementing a selection method as described above.

Each of these programs can use any programming language, and can be in the form of source code, object code, or of intermediate code between source code and object code, such as in a partially compiled format, or in any other desirable format.

The invention also relates to a computer-readable information medium or storage medium, comprising instructions of a computer program as mentioned above.

The information or storage medium can be any entity or device capable of storing programs. For example, the medium can comprise a storage means, such as a ROM, for example, a CD-ROM or a microelectronic circuit ROM, or else a magnetic storage means, for example, a hard disk, or a flash memory.

Moreover, the information or storage medium can be a transmissible medium such as an electrical or optical signal, which can be routed via an electrical or optical cable, via radio link, via wireless optical link or via other means.

The program according to the invention particularly can be downloaded over a network of the Internet type.

Alternatively, the information or storage medium can be an integrated circuit, in which a program is incorporated, with the circuit being adapted to execute or to be used to execute the delivery and selection methods according to the invention.

According to another aspect, a further aim of the invention is a system in a communication network comprising:
at least one device for collecting and analyzing network data comprising a first delivery entity according to the invention;
a device for managing profiles of a plurality of devices hosting network functions of the network, comprising a second delivery entity according to the invention; and
a device hosting a network function of the network and comprising a selection entity according to the invention.

For example, in this system:
the first delivery entity can be configured to provide the profile management device with the weights assigned to the elementary areas covered by a service area of the collection and analysis device; and
the selection entity can be configured to send a discovery request relating to a given search criterion to the management device and to receive, in response to this discovery request, from the second delivery entity, weights assigned to the elementary areas of the service areas of candidate devices meeting said search criterion.

The system according to the invention has the same aforementioned advantages as the delivery and selection methods, and as the delivery and selection entities, according to the invention. It is preferably applicable within the context of a 5G network for notably selecting an NWDAF network function instance, whether within the context of access to the functionalities offered by this network function or within the context of a transfer procedure between two NWDAF network function instances. In the latter case, the device of the system according to the invention hosting a network function of the network is one of said collection and analysis devices.

It is also possible to contemplate, in other embodiments, that the delivery and selection methods, the delivery and selection entities and the system according to the invention in combination have all or some of the aforementioned features.

### BRIEF DESCRIPTION OF THE DRAWINGS

Further features and advantages of the present invention will become apparent from the following description, with reference to the appended drawings, which illustrate an exemplary embodiment that is by no means limiting. In the figures:

FIG. 1, already described, illustrates a situation in which several candidate instances are available in order to provide an NWDAF network function in a 5G network;

FIG. 2 shows, in its environment, a system in a communication network according to the invention, in a particular embodiment;

FIG. 3 schematically shows the hardware architecture of a computer capable of hosting any one of the entities according to the invention belonging to the system of FIG. 2;

FIG. 4 shows the functional modules of the devices of the system of FIG. 2;

FIGS. 5 and 6 respectively use flowcharts to show the main steps of a delivery method according to a second alternative embodiment and according to a first alternative embodiment of the invention;

FIG. 7 illustrates an example of a communication network in which the system of FIG. 2 is located and illustrates various service areas served by devices of this system;

FIG. 8 illustrates another example of service areas assigned to two network function instances of a communication network;

FIG. 9 uses a flowchart to show the main steps of a selection method according to the invention; and

FIG. 10 also uses a flowchart to show the main steps of a selection method according to the invention when it is used within the context of a transfer procedure.

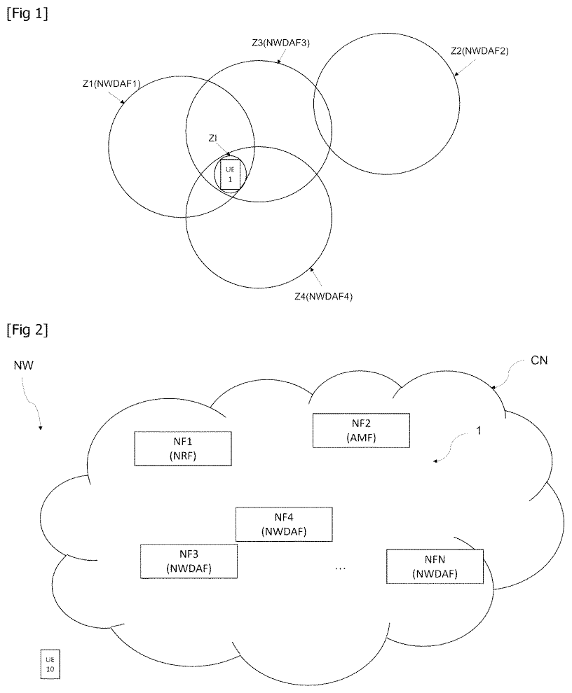

### DETAILED DESCRIPTION OF ILLUSTRATIVE EMBODIMENTS

FIG. 2 shows a system 1 according to the invention in its environment, in a particular embodiment in which it is located in a cellular communication network NW based on a 5GC core network as defined by the 3GPP standard (subject to the arrangements related to the implementation of the invention),

In the particular embodiment described herein, the system 1 comprises a plurality of devices NF1, . . . , NFN of the core network CN, with N denoting an integer number greater than 1, hosting network function instances implementing various functionalities within the core network CN, with each network function instance NFn, n=1, . . . , N serving a service area Zn. A service area assigned to a network function instance corresponds to the geographical area served by this instance, i.e., the area over which it provides the one or more functionalities it is responsible for within the core network CN. The definition of this service area can depend on the functionalities provided by the instance in question.

For example, for an NWDAF network function instance that collects and analyzes data concerning UEs, this service area can be defined as a function of the location of the UEs: an NWDAF instance can be assigned to the northern portion of a country covered by the network NW, while another NWDAF instance can be assigned to the southern portion of the country in question. For an NWDAF network function instance that collects and analyzes data collected from other NF functions (for example, load, etc.), the service area of this network function instance can be defined relative to the location of these NF functions (for example, one per region of a country covered by the network NW).

Such a service area generally covers an integer number K of elementary areas associated with the network (in other words, defined within the context of the network), that is greater than or equal to 1, typically an integer number K of cells of the cellular network NW, with K of course being able to vary from one device to another.

As a variant, other types of elementary areas can be contemplated as units for defining the service areas, such as, for example, a location area or TA. Such a location area is made up of one or more cells of the network and corresponds to the geographical area within which a user equipment can move without having to update its registration with the core network CN. According to yet another variant, it is possible to contemplate predefined geographical areas as elementary areas, with said predefined geographical areas forming a mosaic of the coverage area of the network and being independently defined relative to the network strictly speaking and to its operational functionality, such as, for example, geographical areas with fixed dimensions such as squares with 10 km sides.

There is no limit associated with the type of network functions hosted by the devices NF1, . . . , NFN. In the example shown in FIG. 2, it is assumed, by way of an illustration, that:
the device NF1 hosts an NRF type network function instance, and, in a manner per se known, maintains a catalogue of the profiles of the other network functions (i.e., of their various instances, if applicable) of the core network CN. Each profile associated with a network function instance, generally referenced NFPROF, contains miscellaneous information such as the identity of the instance, the corresponding type of network function, its service features (for example, how it can be joined, the resources it manages, etc.), its operational state (for example, its availability, its load, etc.), the service area served by the instance, etc. The device NF1, in order to keep this profile catalogue up-to-date and to publish all or some of the information it contains, relies on a plurality of services notably comprising discovery and management services (including the registration/deregistration/updating operations), which in this case respectively use the Nnrf_NFDiscovery and Nnrf_NFManagement service logic described in documents 3GPP TS 23.502 entitled “Technical Specification Group Services and System Aspects; Procedures for the 5G System (5GS); Stage 2; (Release 17)”, V17.4.0, March 2022, and TS 29.510 entitled “Technical Specification Group Core Network and Terminals; 5G System; Network Function Repository Services; Stage 3; (Release 17)”, V17.5.0, March 2022 (subject to the arrangements required by the invention described hereafter). More specifically, in the embodiment described herein, the device NF1 comprises a delivery entity according to the invention according to a first alternative embodiment, so that all or some of the profiles maintained by the device NF1 are enhanced with additional information, as described in further detail hereafter;
the device NF2 hosts an AMF network function instance, implementing functionalities for managing access and mobility in the network. In the embodiment described herein, the device NF2 comprises a selection entity according to the invention; and
the devices NF3, . . . , NFN host NWDAF network function instances, implementing network data collection and analysis functionalities. Each of these devices in this case comprises a delivery entity according to the invention according to a second alternative embodiment, as well as a selection entity according to the invention.

It should be noted that the core network CN comprises, in a manner per se known, other devices hosting network function instances offering other functionalities required for the operational functioning of the core network CN, and more generally of the network NW. For example, the core network CN comprises SMF (“Session Management Function”) network function instances for managing sessions, PCF (“Policy Control Function”) network function instances for managing the flow policy, etc.

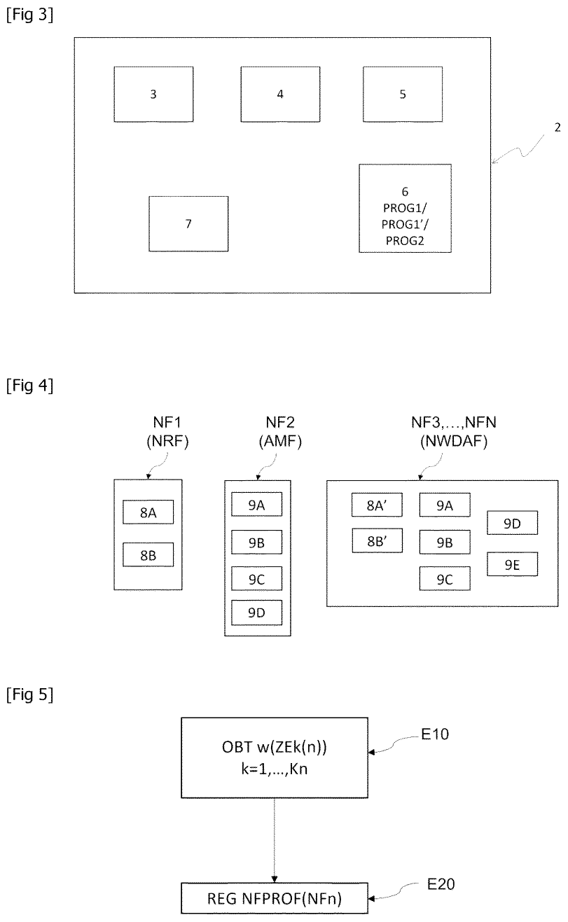

In the embodiment described herein, the devices NF1, . . . , NFN have the hardware architecture of a computer 2, as shown in FIG. 3.

The computer 2 notably comprises a processor 3, a random-access memory 4, a read-only memory 5, a non-volatile memory 6, and communication means 7 notably allowing the devices NF1, . . . , NFN of the system 1 to communicate with each other and with other devices, if applicable, of the core network CN and/or more generally of the cellular network NW. These communication means 7 are based, on the one hand, on a wired or wireless communication interface, per se known and not described in further detail herein, but also, on the other hand, in this case on one or more Service Based Interface (SBI) software interfaces.

The non-volatile memory 6 of the computer 2 forms a storage medium according to the invention that can be read by the processor 3 and stores one or more computer programs according to the invention.

More specifically, the non-volatile memory 6 of the computer 2 includes, when it is the device NF1 (which hosts an NRF function), a recording of a computer program PROG1 comprising instructions defining the main steps of a delivery method according to the invention according to the first alternative embodiment.

This program PROG1 defines functional modules of a delivery entity according to the first alternative embodiment of the invention that use or control the aforementioned hardware elements 3 to 7 of the computer 2. These modules notably comprise, as illustrated in FIG. 4:
an acquisition module 8A, configured to acquire, from at least one device (acting as a first device within the meaning of the invention) hosting a network function instance managed by the device NF1 and for which the device NF1 stores the profile and keeps it up-to-date, a weight assigned to at least one elementary area covered by the service area served by this network function instance, with this weight being a real number (for example, a rational number such as a percentage) that is greater than or equal to 0. In the example contemplated in FIG. 2, it is assumed that the acquisition module 8A notably acquires such weights for each of the devices NF3, . . . , NFN of the core network CN hosting an NWDAF network function, and for each elementary area covered by each service area of the devices NF3, . . . , NFN. As a variant, it is possible to contemplate assigning and acquiring weights (in particular non-zero weights) only for the elementary areas covered by several service areas of devices hosting the same NWDAF network function. These weights are acquired by the device NF1, and more specifically by its module 8A, when the devices NF3, . . . , NFN register their profiles therewith and/or when updating these profiles; to this end, the devices NF3, . . . , NFN in this case use the Nnrf_NFManagement service offered by the device NF1 adapted to transmit the weights of the elementary areas, as will be described further hereafter; and
a delivery module 8B, configured to provide a consumer device of the core network CN (acting as a second and a fourth device within the meaning of the invention), when the device NF1 is polled by the consumer device by means of a discovery request relating to at least one search criterion CRIT (as defined, for example, within the context of the Nnrf_NFDiscovery service implemented by the device NF1), with the weights acquired by the acquisition module 8A, assigned to the elementary areas covered by the service areas of the devices whose profile it stores and which meet the search criterion CRIT. Such a search criterion CRIT includes, for example, a type of network function implemented by the devices (for example, NWDAF function), an area of interest that the devices must serve, etc. The weights are delivered by the delivery module 8B in the response to the search request sent by the device NF1 to the consumer device. In the illustrative examples described hereafter, the device NF2 hosting an AMF network function, and the device NF3 hosting an NWDAF network function are considered to be a consumer device. Of course, these examples are provided solely by way of an illustration and other consumer devices can be contemplated as a variant.

The operation of the modules 8A and 8B of the device NF1 is described in further detail hereafter with reference to the steps of the delivery method according to the first alternative embodiment of the invention.

When the computer 2 is the device NF2 (which hosts an AMF function in the illustrative example contemplated herein) or a device NF3, . . . , NFN (which hosts an NWDAF function instance and acts as second and fourth devices within the meaning of the invention), the non-volatile memory 6 of the computer 2 includes a recording of a computer program PROG2, comprising instructions defining the main steps of a selection method according to the invention.

This program PROG2 defines functional modules of a selection entity according to the invention, integrated into the device NF2 and into each of the devices NF3, . . . , NFN, using or controlling the aforementioned hardware elements 3 to 7 of the computer 2. These modules notably comprise, in the embodiment described herein and as illustrated in FIG. 4:
a sending module 9A, configured to send a device of the core network CN, in this case the device NF1 hosting the NRF network function (acting as a fifth device within the meaning of the invention), a request to discover devices of the core network CN hosting network functions and meeting at least one given search criterion CRIT, as described above (for example, type of network function implemented by the device, area of interest, etc.);
an acquisition module 9B, configured to acquire a response to this discovery request identifying at least one device of the core network CN, called candidate device, hosting a network function and meeting said at least one given search criterion CRIT. This response includes, for each candidate device with a service area covering an area of interest defined by the selection entity (as a whole in the embodiment described herein), the weight stored in the profile of the candidate device assigned to each elementary area covered by said service area and by the area of interest, with said weight being a real number greater than or equal to 0. It should be noted that, for the sake of completeness, the response can also include the weights of the elementary areas covered by the service area of the candidate device that are not included in the area of interest;
a determination module 9C, configured to determine, for each candidate device identified in the acquired response, a metric based on the weights assigned to the elementary areas covered by this service area and the area of interest; and
a selection module 9D, configured to select a candidate device for implementing at least one functionality of the network function that it hosts, by comparing the weights assigned to the elementary areas covered by the area of interest acquired by the acquisition module 9B for each candidate device identified in the response. In the embodiment described herein, the selection module 9D uses the metrics determined by the determination module 9C for the various candidate devices identified in the response and selects the candidate device corresponding to the optimum determined metric.

When it is stored in the non-volatile memory 6 of a device NF3, . . . , NFN, the program PROG2 also defines a transfer module 9E that is configured to implement a transfer procedure, such as that described, for example, in 3GPP document TS 23.288, and to transfer all or some of the subscriptions the device NF3, . . . , NFN is responsible for to the candidate device selected by the selection module 9D. This transfer module 9E is also configured to initiate a phase of preparing the transfer procedure with the selected candidate device, as described in further detail hereafter. In the example of a transfer between two devices hosting an NWDAF function, this preparation phase notably involves the transfer module 9E sending the selected candidate device information concerning the subscriptions that will be transferred thereto so that the selected candidate device is able to collect data for generating the predictions/statistics required by these subscriptions as soon as the transfer is in effect.

The operation of the modules 9A-9D and, if applicable, 9E, is described in further detail hereafter with reference to the steps of the selection method according to the invention.

Finally, when the computer 2 is a device NF3, . . . , NFN (which hosts an NWDAF function instance and acts as the first devices within the meaning of the invention), the non-volatile memory 6 of the computer 2 includes a recording of a computer program PROG1′, comprising instructions defining the main steps of a delivery method according to the second alternative embodiment of the invention.

This program PROG1′ defines functional modules of a delivery entity according to the second alternative embodiment, integrated into each device NFn, n=3, . . . , N, with these modules using or controlling the aforementioned hardware elements 3 to 7 of the computer 2. They notably comprise, as illustrated in FIG. 4:
an acquisition module 8A′, configured to acquire a weight (real number ranging between 0 and 1) assigned to at least one elementary area covered by the service area served by the device NFn. In the embodiment contemplated herein, a weight is assigned and acquired for each elementary area covered by the service area. However, as mentioned above, it is possible to contemplate assigning and acquiring weights (in particular non-zero weights) only for the elementary areas covered by several service areas of devices implementing the same network function. The acquisition module 8A′ can acquire the weights in various ways: the weights can be assigned statically and empirically or by expert assessment by the operator of the cellular network NW (and of the core network CN) and can be configured on the device NFn by said operator (for example, via an appropriate configuration message or interface, provided for this purpose). As a variant, they can be dynamically evaluated by the acquisition module 8A′ by applying an algorithm that is defined and parameterized by the network operator. Various strategies for assigning weights to the elementary areas can be adopted by the operator. As mentioned above, these weights are intended to guide the selection of one device from among several devices hosting the same network function; the weights are therefore assigned to the elementary areas covered by a service area according to a strategy that is consistent with the selection policy that the network operator wishes to implement in the network, given the functionalities offered by the device in question and the considered context. Examples of an assignment strategy and of assigned weights are described in further detail hereafter;
a delivery module 8B′ for delivering the acquired weights assigned to the elementary areas covered by the service area of the considered device NFn. In the second alternative embodiment, the delivery module 8B′ is configured to deliver these weights to a device of the core network CN managing the devices hosting network functions and storing the profile of these devices. In the example contemplated in FIG. 2, this is the device NF1 hosting the NRF function. More specifically, the delivery module 8B′ is configured to deliver the assigned weights to the elementary areas covered by the service area of the considered device NFn when registering the profile of the device NFn on the device NF1 (using the Nnrf_NFManagement service proposed by the device NF1), for example, in a new attribute of this profile provided for this purpose. The attribute in question notably can use their identifiers to list the elementary areas covered by the service area of the device NFn, and, for each elementary area, can indicate the weight assigned by the network operator thereto. As a variant, it is possible to contemplate supplementing the attribute defining the service area of the device NFn provided in its profile. It should be noted that if a weight assigned to an elementary area covered by the service area of the device NFn is likely to evolve over time, the delivery module 8B′ can update said weight on the device NF1 in order to indicate this evolution. To this end, it can update its profile using, for example, the Nnrf_NFManagement service proposed by the device NF1.

The operation of the modules 8A′ and 8B′ of the devices NF3, . . . , NFN is described in further detail hereafter with reference to the steps of the delivery method according to the second alternative embodiment of the invention.

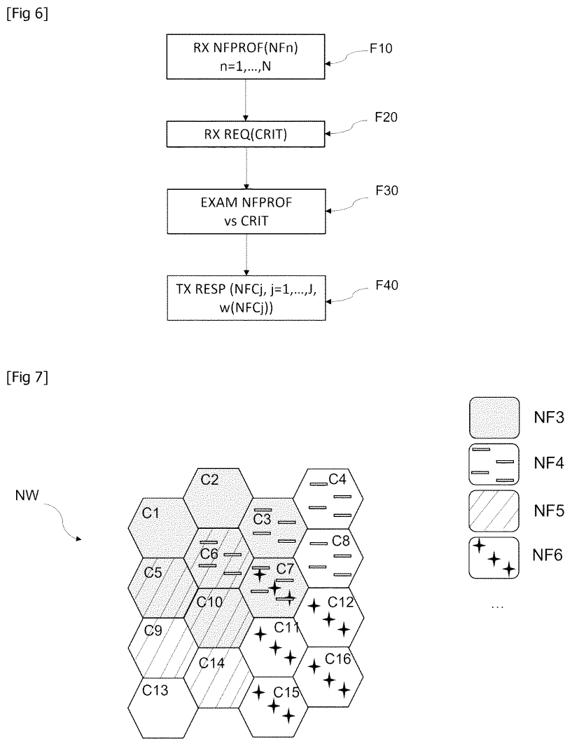

The various steps of the delivery method as implemented by the devices NF3, . . . , NFN and by the device NF1 will now be described with reference to FIGS. 5 and 6, respectively, according to the first and the second alternative embodiment of the invention.

FIG. 5 illustrates the second alternative embodiment, which is implemented by each device NFn, n=3, . . . , N. As indicated above, in the illustrative example contemplated herein, the devices NF3, . . . , NFN host instances of the same NWDAF network function for collecting and analyzing data. These devices are geographically distributed over the coverage area of the network NW, with each device NFn serving a service area Zn in which it implements the one or more functionalities of an NWDAF network function, namely, for example, collecting data representing network facts (for example, the state of a user equipment, a cell in which it is located, etc.) on other network functions and/or radio nodes via the OAM entity of the network, establishing statistics and/or predictions (global and/or individual) from the collected data, etc.

As mentioned above, the service area Zn of the device NFn covers a number Kn of elementary areas ZEk(n), k=1, . . . , Kn associated with the network, with Kn denoting an integer number that is greater than or equal to 1 that can vary from one device NFn to another. In the example contemplated herein, each elementary area ZEk(n) is a cell of the network NW.

FIG. 7 illustrates an example of service areas Z3, Z4, Z5 and Z6 respectively assigned to the devices NF3, NF4, NF5, NF6 hosting an NWDAF network function. In the example of FIG. 7, elementary areas are considered to be hexagonal cells of the network NW referenced C1, C2, . . . , and K3 is considered to be equal to 7, K4 equal to 5, K5 equal to 5, and K6 equal to 5. More specifically:

$$Z 3 = \{ ZE 1 ( 3 ) = C 1 , ZE 2 ( 3 ) = C 2 , ZE 3 ( 3 ) = C 3 , ZE 4 ( 3 ) = C 5 , ZE 5 ( 3 ) = C 6 , ZE 6 ( 3 ) = C 7 , ZE 7 ( 3 ) = C 10 \} ; \\ Z 4 = \{ ZE 1 ( 4 ) = C 3 , ZE 2 ( 4 ) = C 4 , ZE 3 ( 4 ) = C 6 , ZE 4 ( 4 ) = C 7 , ZE 5 ( 4 ) = C 8 \} ; \\ Z 5 = \{ ZE 1 ( 5 ) = C 5 , ZE 2 ( 5 ) = C 6 , ZE 3 ( 5 ) = C 9 , ZE 4 ( 5 ) = C 10 , ZE 5 ( 5 ) = C 14 \} ; \\ and \\ Z 6 = \{ ZE 1 ( 6 ) = C7 , ZE 2 ( 6 ) = C 11 , ZE 3 ( 6 ) = C 12 , ZE 4 ( 6 ) = C 15 , ZE 5 ( 6 ) = C 16 \} .$$

The cell C13 is covered by devices other than the devices NF3, NF4, NF5, NF6.

As illustrated in FIG. 7, the service areas of some of the devices NF3, . . . , NFN can be defined so as to be overlapping. Within the meaning of the invention, overlapping areas are areas that are not disjoint, i.e., which have a non-empty intersection (within the topological meaning of the term). In other words, the same elementary area can be covered by the service areas of several devices providing the same network function. This is notably the case for the cell C6 that is covered by the three service areas Z3, Z4 and Z5 of the devices NF3, NF4 and NF5, for the cell C10 that is covered by the service areas Z3 and Z5 of the devices NF3 and NF5, or else for the cell C7 that is covered by the service areas Z3, Z4 and Z6 of the devices NF3, NF4 and NF6, etc.

It should be noted that the overlapping service areas may have been originally defined in a disjoint manner, and then extended in order to be overlapping, for example, with a view to allowing certain procedures to be executed within the network, notably such as the preparatory phase preceding a transfer procedure between two AMF functions.

According to the invention, the device NFn acquires, by means of its module 8A′, weights (real numbers that are greater than or equal to 0) assigned to each of the elementary areas covered by its service area Zn. As mentioned above, these weights may have been assigned to the elementary areas ZEk(n), k=1, . . . , Kn covered by the service area Zn in various ways. They notably may have been statically assigned by the operator of the cellular network (and of the core network CN) and then may have been configured on the device NFn by said operator, for example, via an appropriate configuration message or interface, provided for this purpose, or may have been dynamically assigned, for example, by the acquisition module 8A′ itself, by executing an algorithm that is defined and parameterized by the network operator. Irrespective of the adopted procedure, the weights can also evolve over time, for example, in case of the disappearance or appearance of an instance of the network function, of momentary unavailability of this instance, a desire to balance the load, etc.

Strictly speaking, in order to assign each weight to each elementary area, a strategy is applied that is consistent with the policy that the network operator wishes to implement in order to select one device from among several devices implementing a given network function. This policy can take into account several factors, such as, for example, the implemented network function, the context in which the elementary areas are located (for example, urban or rural environment) and the possible resulting mobility of the user equipment (for example, high or low mobility), the configuration of the service areas (for example, shape, coverage), etc.

In the embodiment contemplated herein, each weight assigned to an elementary area for the service area Zn of the device NFn reflects the relevance of this device or equally the priority granted thereto (for example, by the network operator NW) for providing the NWDAF network function in this elementary area (for example, in view of the preferences of the operator), taking into account the fact that this same network function can be executed by other devices serving this same elementary area, and that the UEs (user equipments) to which the statistics and/or predictions entrusted to the NWDAF network function are likely to relate are likely to move. The weight w(ZEk(n)) assigned to the elementary area ZEk(n), for k=1, . . . , Kn therefore in this case takes into account the fact that this elementary area may or may not be covered by other devices NFj, with j=3, . . . , N, j≠n: notably, each weight is expressed in the form of a percentage and the sum of the weights assigned to an elementary area covered by several service areas is normalized (i.e., taken as equal to 1 or equally to 100%) over all of said service areas. Various weights are also assigned for the same elementary area to the various service areas associated with devices hosting the same network function and covering this elementary area. Of course, other choices can be contemplated, such as, for example, assigning non-normalized absolute weights (i.e., the sum of which is not equal to 1) but expressed according to the same scale, rather than relative weights such as percentages, having a sum of the weights that is less than 1 or different from 1, assigning real weights rather than rational weights, assigning, for certain service areas, identical weights when it covers the same elementary area (for example, when not intending to grant priority to one of the service areas over the other for this elementary area), etc.

Various criteria can be contemplated for assigning a weight to an elementary area covered by a service area. Thus, according to an illustrative but non-limiting example, when the same elementary area is covered by several service areas assigned to various devices hosting the same network function, in order to take into account the potential mobility of the UEs attached to a device NFn, the weight assigned to this elementary area for a device NFn can depend on its distance (evaluated, for example, by taking its center or its barycenter as a reference) relative to the center of the service area Zn of the considered device NFn or on its distance relative to the limits of the service area Zn: for example, the further the elementary area is away from the center (or from the barycenter) of the service area Zn or the closer it will come to an edge or to the border of the service area Zn, the lower the weight that can be selected that is assigned for this service area compared to the service areas of the other devices covering the elementary area, so as to reflect that the device NFn is of lower “priority” than the other devices in this elementary area.

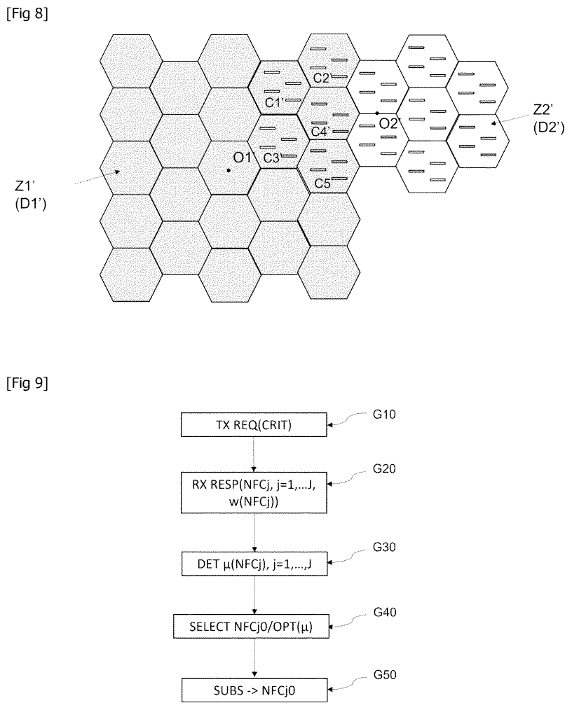

FIG. 8 simply illustrates this principle for two devices D1′ and D2′ hosting instances of the same network function, to which the service areas Z1′ and Z2′ are respectively assigned. The centers of the service areas Z1′ and Z2′ are denoted O1′ and O2′, respectively. Furthermore, in FIG. 8, for the sake of simplification, only the cells covered by the two devices are referenced C1′, C2′, C3′, C4′ and C5′. Thus, in this example, in accordance with the principle mentioned above, a greater weight is assigned to the cell C4′ for the device D2′ than for the device D1′: indeed, the cell C4′ is located at the edge of the service area Z1′ of the device D1′, while it is located away from the edge of the service area Z2′. Conversely, a lower weight is assigned to the cell C3′ for the device D2′ than for the device D1′.

It should be noted that the weights assigned to the various elementary areas of the same service area do not need to be normalized, with the selection not occurring within the same service area, but between several devices with overlapping service areas. Furthermore, if an elementary area is only covered by a single service area for a given network function, in the embodiment described herein, the maximum weight (for example, 100%) is assigned thereto.

In an alternative embodiment, a weight, in particular a non-zero weight, can be assigned only to the elementary areas covered by service areas associated with several devices hosting the same network function, and when wishing to assign different weights to these overlapping elementary areas.

Thus, in view of the above, the weight assigned to an elementary area for the service area Zn in some way reflects the more or less significant attachment of this elementary area to the service area Zn and therefore to the device NFn serving this service area; in other words, this means that, when covering this elementary area is involved, it is worthwhile selecting the device NFn or another more relevant and more appropriate device. The weights assigned to the same elementary area for various service areas covering this elementary area therefore allow different priorities to be assigned to the associated devices, and therefore allows the selection of one device from among the others to be guided based on these priorities. It should be noted that, conversely, when not intending to establish priority between two devices implementing the same network function, the same weight can be allocated to an elementary area for the service areas of these two devices.

Factors or criteria other than the distance and/or the proximity to the border of the service area of a device can be taken into account in order to assign a weight to an elementary area for a given device NFn, n=3, . . . , N. For example, it is also possible to take into account a policy for distributing the load between several devices implementing the same network function on an elementary area. This factor notably can be taken into account to justify the assignment of two different weights to an elementary area covered by two distinct devices and that are located at an equal distance from the center of the service areas served by these devices or from the border of these service areas. It is also possible to take into account, as mentioned above, the application context of the invention, the strategy that the network operator wishes to adopt, the topology of the network, etc.

By way of an illustration, in the example of FIG. 7, by applying the aforementioned strategy (weights assigned as a function of the distance to the centers or to the edges of the service areas), the following rational weights, denoted w, have been assigned by the network operator to the elementary areas of the service areas Z3, Z4, Z5 and Z6:
for the device NF3 and the corresponding service area Z3:

$$w ( ZE 1 ( 3 ) = C 1 ) = 100 \% ;$$

$$w ( ZE 2 ( 3 ) = C 2 ) = 100 \% ;$$

$$w ( ZE 3 ( 3 ) = C 3 ) = 40 \% ;$$

$$w ( ZE 4 ( 3 ) = C 5 ) = 40 \% ;$$

$$w ( ZE 5 ( 3 ) = C 6 ) = 70 \% ;$$

$$w ( ZE 6 ( 3 ) = C 7 ) = 20 \% ;$$

$$w ( ZE 7 ( 3 ) = C 10 ) = 40 \% ;$$

for the device NF4 and the corresponding service area Z4:

$$w ( ZE 1 ( 4 ) = C 3 ) = 60 \% ; \\ w ( ZE 2 ( 4 ) = C 4 ) = 100 \% ; \\ w ( ZE 3 ( 4 ) = C 6 ) = 20 \% ; \\ w ( ZE 4 ( 4 ) = C 7 ) = 10 \% ; \\ w ( ZE 5 ( 4 ) = C 8 ) = 100 \% ;$$

for the device NF5 and the corresponding service area Z5:

$$w ( ZE 1 ( 5 ) = C 5 ) = 60 \% ; \\ w ( ZE 2 ( 5 ) = C 6 ) = 10 \% ; \\ w ( ZE 3 ( 5 ) = C 9 ) = 100 \% ; \\ w ( ZE 4 ( 5 ) = C 10 ) = 60 \% ; \\ w ( ZE 5 ( 5 ) = C 14 ) = 100 \% ;$$

for the device NF6 and the corresponding service area Z6:

$$w ( ZE 1 ( 6 ) = C 7 ) = 70 \% ; \\ w ( ZE 2 ( 6 ) = C 11 ) = 100 \% ; \\ w ( ZE 3 ( 6 ) = C 12 ) = 100 \% ; \\ w ( ZE 4 ( 6 ) = C 15 ) = 100 \% ; \\ w ( ZE 5 ( 6 ) = C 16 ) = 100 \% .$$

It should be noted that, according to this example, a weight of 100% has been assigned to an elementary area for a given device when this device is the only one to cover this elementary area. It should be noted that this does not rule out the possibility of having two elementary areas located at the same distance from the center of a service area covering it assigned different weights, since in this case the management of the overlapping areas is of interest.

Thus, in the illustrative example of FIG. 7, priority is given to selecting the device NF3 for covering the cell C6, to selecting the device NF4 for covering the cell C3, to selecting the device NF6 for covering the cell C7, etc.

Of course, this example is provided solely by way of an illustration, and other weights can be assigned.

The weights thus assigned to the various elementary areas of the network covered by the service area Zn of the device NFn are stored, for example, in the non-volatile memory 6 of the computer 2 hosting the device NFn. With reference to FIG. 5, they thus can be acquired by the module 8A′ of the device NFn by consulting this memory (step E10).

They are then delivered, via its delivery module 8B′, to the device NF1 storing the profiles of the network function instances operating in the core network CN (step E20). More specifically, in the second alternative embodiment described herein, the weights w(ZEk(n)) assigned to the various elementary areas ZEk(n) of the network covered by the service area Zn of the device NFn are delivered to the device NF1 implementing the NRF network function when registering the profile NFPROF(NFn) of the device NFn with the device NF1. This registration in this case is based on the Nnrf_NFManagement service proposed by the device NF1, as described in the aforementioned document TS 23.501, arranged so that the device NFn can declare in its profile, in addition to its service area Zn as already provided by the 3GPP standard, as well as its various service features, the weights w(ZEk(n)), k=1, . . . , Kn assigned to each of the Kn elementary areas (i.e., cells in the example contemplated herein) of the network covered by the service area Zn.

It should be noted that if all or some of the weights assigned to the elementary areas ZEk(n) of the network covered by the service area Zn of the device NFn evolve over time, the module 8B′ of the device NFn can provide the weights that have evolved (or all the weights again) by updating its profile, again using, for example, the Nnrf_NFManagement service proposed by the device NF1 that allows such updating, arranged to include an update of the weights.

The assignment of the weights to the elementary areas and the steps of acquiring E10 and of providing E20 these weights are executed in a similar or identical manner by each of the devices NF3, . . . , NFN.

The delivery method according to the first alternative embodiment as implemented by the device NF1 will now be described with reference to FIG. 6.

According to this first alternative embodiment and following the step E20 described above, the device NF1 acquires, via its acquisition module 8A, for each device NFn, n=3, . . . , N, the weights w(ZEk(n)) assigned to the various elementary areas ZEk(n) of the network covered by the service area Zn of the device NFn when registering the profile NFPROF(NFn) of the device NFn (or when updating this profile) (step F10). The acquisition module 8A stores the profiles of the devices NFn in the non-volatile memory 6 of the computer 2 hosting the device NF1. The same applies in the event of an update.

The weights assigned to the elementary areas covered by the service areas of the devices NF3, . . . , NFN in this way can be easily made available (i.e., delivered) to the consumer network function instances of the network CN wishing to use these devices to collect and/or analyze data, like the other information stored in the profile of these devices. To this end, the consumer instances can use, for example, the Nnrf_NFDiscovery service implemented by the device NF1. A “consumer” device can notably access the weights assigned to the elementary areas of the network covered by the service area of a device NFn, n=3, . . . , N by sending a discovery request to the device NF1, as described in further detail hereafter with reference to FIG. 9.

FIG. 9 illustrates the main steps of a selection method according to the invention implemented in a particular embodiment by a consumer device of the network, such as the device NF2 in the example contemplated in FIG. 2.

As mentioned above, it is assumed in this case that the device NF2 hosts an AMF network function and wishes, in order to meet the requirements of this network function, to access statistics and/or predictions established by an NWDAF network function of the core network CN and relating to a UE, referenced using reference numeral 9 in FIG. 2, attached thereto (in other words that is managed thereby).

To this end, it uses its sending module 9A to send a discovery request REQ to the device NF1 providing the NRF network function in the core network CN (step G10). The discovery request REQ sent by the device NF2 aims to discover the devices of the network CN hosting a network function and in this case meeting two search criteria CRIT specified in the request, namely a particular type of network function (NWDAF in the example contemplated herein) and an area of interest ZI defined by the consumer device NF2.

As a variant, the discovery request REQ can relate to a greater or lesser number of criteria; for example, the discovery request can specify only the network function that the searched devices must implement, and/or can relate to other criteria (for example, particular statistics or predictions, etc.).

In the example contemplated herein, the area of interest ZI corresponds to the area where the UE 10 is located. It is derived in this case by the device NF2 from the registration area RA assigned to the UE 10. For example, the area of interest ZI is the area RA assigned to the UE 10 when sending the discovery request REQ; this area RA comprises one or more elementary areas of the network NW (for example, one or more cells). In the illustrative example shown in FIG. 7, it is assumed that the area RA of the UE 10, and therefore the area of interest ZI, contains only the cell C6.

With reference to FIG. 6, upon reception of the discovery request REQ by the device NF1 (step F20), said device uses its delivery module 8B to examine the profiles available in its non-volatile memory 6 in order to identify the devices of the network CN (candidate devices within the meaning of the invention) meeting the criteria CRIT (NWDAF function, ZI=RA (UE 10)) specified in the request REQ (step F30). The candidate devices thus identified are denoted NFCj, j=1, . . . . J, with J being an integer number greater than or equal to 1. In the illustrative example contemplated in FIG. 7, the candidate devices are identified by the delivery module 8B from among the devices NF3, . . . , NFN implementing the NWDAF network function and the delivery module 8B determines that the candidate devices NF3, NF4 and NF5 have a service area covering the whole of the area of interest ZI. In other words, J=3 and NFC1=NF3, NFC2=NF4 and NFC3=NF5.

The device NF1 therefore responds to the discovery request REQ of the device NF2, via its delivery module 8B, by identifying the candidate devices NFCj, j=1, . . . , J in its response RESP that meet the criteria CRIT and the service features contained in the profiles NFPROF of these candidate devices and likely to be of interest to the device NF2 (step F40). According to the invention, it also includes the weights assigned to the elementary areas covered by the service areas of the candidate devices NFCj, j=1, . . . , J in its response RESP. Thus, in the illustrative example contemplated with reference to FIG. 7, it includes the weights w(ZEk(n)), k=1, . . . , Kn for n=3, 4 and 5.

It should be noted that in the embodiment described herein, the device NF1 sends the device NF2 not only the weights assigned to the elementary areas included in the area of interest ZI, but also the weights assigned to the elementary areas not included in this area ZI. An example of the use of these weights outside the area of interest ZI is described in further detail hereafter.

As a variant, only the weights corresponding to the elementary areas covering the area of interest ZI are included in the response RESP, if such an area of interest has been specified in the discovery request as a criterion CRIT. This variant allows the size of the message sent by the device NF1 to the device NF2 to be limited; however, it requires additional filtering power from the device NF1.

With reference to FIG. 9, upon reception of the response RESP by the acquisition module 9B of the device NF2 (step G20), if J>1, the device NF2 compares the weights assigned to the elementary areas covering the area of interest ZI acquired for the various candidate devices NFCj, j=1, . . . , J. In the embodiment described herein, in order to carry out this comparison, the device NF2 determines, via its determination module 9C, for each candidate device NFCj, j=1, . . . , J identified in the response RESP, a metric denoted μ(NFCj) based on the weights assigned to the elementary areas covered by the service area of this candidate device and by the area of interest ZI (step G30).

It should be noted that if the area of interest ZI is not included in the search criteria CRIT specified in the search request, the determination module 9C selects the devices from among the candidate devices NFCj, j=1, . . . , J identified in the response RESP that have a service area covering the area of interest, and only determines the metric μ(NFCj) for the candidate devices thus selected.

In the embodiment described herein, the metric μ(NFCj) computed by the determination module 9C for each relevant candidate device NFCj is the sum of the weights assigned to the elementary areas covered by the service area of this candidate device and by the area of interest ZI.

As a variant, it is possible to contemplate applying weighting factors to each weight (for example, ranging between 0 and 1). An example of such a weighted sum is provided hereafter.

In the illustrative example contemplated with reference to FIG. 7 (NF3, NF4 and NF5 identified as candidate devices and area of interest ZI containing the cell C6), the metrics evaluated by the determination module 9C are as follows:

$$μ ( NFC 1 = NF 3 ) = 70 \% ; \\ μ ( NFC 2 = NF 4 ) = 20 \% ; \\ μ ( NFC 3 = NF 5 ) = 10 \% .$$

The selection module 9D of the device NF2 then selects the candidate device NFCj0 optimizing the metric u in order to implement the NWDAF network function sought by the device NF2 (step G40), in other words, in the embodiment described herein, that which maximizes the metric μ (it should be noted that according to the contemplated metric μ and how the weights are assigned to the elementary areas, the module 9D may be required to select the candidate device minimizing the metric μ in order to optimize it). In the illustrative example contemplated herein, it is the device NF3 that is selected to implement the NWDAF function the device NF2 requires on the area of interest ZI={C6}.

Following this selection, the device NF2 sends its request to the selected device NFCj0, with this request indicating the statistics and/or predictions sought by the device NF2 (step G50).

Sometimes, when executing the functionalities assigned thereto, a network function instance (for example, the device NF3 selected during step G50) must fully or partly transfer the requests that it has been sent to another instance implementing the same network function. This transfer from an instance, called “source” instance, to an instance, called “target” or relay instance, can be initiated for internal reasons (for example, balancing the load, gradually shutting down the instance, etc.), or for external reasons (for example, mobility of a user equipment it is responsible for) indicated, for example, by other network functions it has subscribed to in order to be notified of the corresponding events. Such a transfer requires the selection of a new network function instance (i.e., the target instance or the instance equally acting as a relay).

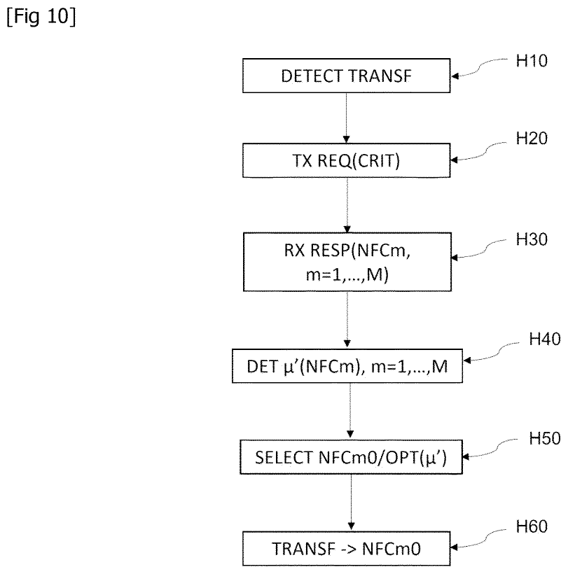

FIG. 10 represents the main steps implemented in this case by the previously selected device NF3 (source device) when such a situation arises, requesting a transfer to a target instance also implementing the NWDAF network function to act as a relay to the device NF3 for all or some of the functionalities that it implements. These steps use, subject to a few arrangements as appropriate, the steps of the selection method according to the invention that have been described above.

More specifically, it is assumed that the device NF3 detects that a transfer to another NWDAF instance is required for all or some of the subscriptions or requests it has been sent, and more specifically in this case, prediction and statistics requests sent by the device NF2 in relation to the UE 10 (step H10). As mentioned above, detecting that a transfer is necessary can use information fed back by other network functions of the core network CN, notably such as the notification of events to which the device NF3 has previously subscribed. For example, the device NF3 can, based on the location information of the UE 10 fed back to it from the device NF2 (AMF), detect that the UE 10 moves and determine if it is still able to provide the analysis and prediction service requested by the device NF2 or whether it must transfer the corresponding subscriptions from the device NF2 to another NWDAF instance (target instance).

In the embodiment described herein, following this detection, the device NF3 selects the target NWDAF instance (or equally the device hosting this target instance) intended for the transfer if said instance is confirmed. To this end, it sends a discovery request REQ to the device NF1 (step H20) comprising at least one criterion CRIT to be met by the searched devices. Within the context of a transfer procedure between two devices implementing an NWDAF network function, the discovery request includes the NWDAF type as a criterion. It can also optionally include an area of interest defined by the device NF3, corresponding, for example, to the current location of the UE 10. It is assumed in this case, by way of an illustration, that the area of interest ZI specified in the discovery request is the area RA of the UE 10, and more specifically the cell C7 in the example of FIG. 7, with the UE 10 having moved from the cell C6 to the cell C7 following the selection of the device NF3. The sending step H20 is identical to the step G10 previously described with reference to FIG. 8.

Steps F20, F30 and F40, already described, are implemented by the device NF1 upon reception of this discovery request REQ. It is assumed in this case that the response RESP sent by the device NF1 to the device NF3 in step F40 identifies the candidate devices NFCm, m=1, . . . , M, with M denoting an integer number greater than 1, and provides the device NF3, for each of these candidate devices, with the weights associated with the elementary areas covered by the service areas of these candidate devices (or only those assigned to the elementary areas covered by the service areas of the candidate devices and by the area of interest ZI specified in the discovery request, if applicable). With reference to the illustrative example shown in FIG. 7, it is assumed, for example, that the response RESP sent to the device NF3 identifies the devices NF3, NF4 and NF6.

Upon reception of this response (step H30, which is identical to step G20), if the number of candidate devices distinct from the device NF3 is greater than 1, the device NF3 compares the weights assigned to the elementary areas covering the area of interest ZI acquired for the various candidate devices NFCm, m=1, . . . , M, with NFCm≠NF3. More specifically, in order to carry out this comparison, the device NF3 in this case determines, via its determination module 9C, for each candidate device NFCm, m=1, . . . , M, with NFCm≠NF3, identified in the response RESP, a metric denoted μ′(NFCm) based on the weights assigned to the elementary areas covered by the service area of this candidate device and by the area of interest defined by the device NF3 (step H40). It should be noted that if a single candidate device distinct from the device NF3 is identified in the received response, the determination module 9C selects this candidate device as a potential relay of the device NF3 and initiates the transfer thereto of all or some of the subscriptions it is sent by the device NF2 when the transfer requirement is confirmed (for example, when the device NF3 detects that the UE 10 is located in the cell C8, outside the coverage of the device NF3).

As mentioned above, if the area of interest ZI is not included in the search criteria CRIT specified in the search request, the determination module 9C selects, from among the candidate devices NFCm, m=1, . . . , M identified in the response RESP, those with a service area covering the entire area of interest, and only determines the metric μ′(NFCm) for the candidate devices thus selected,

In the embodiment described herein, the metric μ′(NFCm) computed by the determination module 9C of the device NF3 for each relevant candidate device NFCm different from NF3 is the weighted sum of the weights assigned to the elementary areas covered by the service area of this candidate device and by the area of interest. In the example contemplated herein of a transfer that is required due to the mobility of the UE 10, the weighting factors applied to the weights assigned to each elementary area represent the probability of the presence of the UE 10 in this elementary area over a certain time scale (for example, within the next 10 minutes). In other words, the device NF3 takes into account a prediction of mobility of the UE 10 in order to select the candidate device to transfer to if it is confirmed. Such probabilities of presence can be determined, for example, by the device NF3 based on the data that it collects for the device NF2 (it has been noted already that they can form part of the statistics/predictions requested by the device NF2 from the device NF3). As a variant, it can acquire these probabilities of other network functions of the core network CN.

It should be noted that weighting factors other than probabilities of the presence of the UE 10 can be applied in the weighted sum to the weights of the elementary areas, or to compute the metric μ′(NFCm) associated with each candidate device, notably if the transfer is contemplated for a reason other than the mobility of the UE 10. The applied weighting factors may or may not be selected in connection with the reason for the transfer. For example, it is possible to apply, as in step G30 described above, unitary weighting factors to each weight considered in the metric. According to another example, it is possible to contemplate using other information contained in the profiles of the candidate devices stored in the device NF1 as weighting factors, such as the load levels of the candidate devices, for example.

By way of an illustration, it is assumed that the device NF3 determines the following probabilities, denoted Prob, of the presence of the UE 10 in the elementary areas covered by the candidate devices identified in the response RESP (NF4 and NF6 in the illustrative example contemplated herein):

$$Prob ( C 3 ) = 0 \% ; \\ Prob ( C 4 ) = 0 \% ; \\ Prob ( C 6 ) = 0 \% ; \\ Prob ( C 7 ) = 30 \% ; \\ Prob ( C 8 ) = 50 \% ; \\ Prob ( C 11 ) = 10 \% ; \\ Prob ( C 12 ) = 10 \% ; \\ Prob ( C 15 ) = 0 \% ; \\ Prob ( C 16 ) = 0 \% .$$

According to this example, the sum of the probabilities over all the elementary areas covered by the candidate devices is normalized. However, it should be noted that such normalization is not compulsory. It can notably depend on how the probability of the presence of the UE in a given elementary area is defined. For example, if this probability is defined as the probability that the UE is located in this elementary area at least once in a given time scale, the sum of the acquired probabilities can be greater than 1. However, if the probability of the presence of a UE in an elementary area at a given instant is considered, the sum of the probabilities is normalized by definition.

This yields the following metrics:

$$\begin{matrix}{μ}^{′} ( NFC 1 = NF 4 ) = w ( ZE 1 ( 4 ) = C 3 ) \cdot Prob ( C 3 ) + w ( ZE 2 ( 4 ) = C 4 ) \cdot \\ Prob ( C 4 ) + w ( ZE 3 ( 4 ) = C 6 ) \cdot Prob ( C 6 ) + \\ w ( ZE 4 ( 4 ) = C 7 ) \cdot Prob ( C 7 ) + w ( ZE 5 ( 4 ) = C 8 ) \cdot \\ Prob ( C 8 ) \\ = 10 \% \times 30 \% + 100 \% \times 50 \% \\ = 53 \%\end{matrix} ;$$

$$and :$$

$$\begin{matrix}{μ}^{′} ( NFC 2 = NF 6 ) = w ( ZE 1 ( 6 ) = C 7 ) \cdot Prob ( C 7 ) + w ( ZE 2 ( 6 ) = C 11 ) \cdot \\ Prob ( C 11 ) + w ( ZE 3 ( 6 ) = C 12 ) \cdot Prob ( C 12 ) + \\ w ( ZE 4 ( 6 ) = C 15 ) \cdot Prob ( C 15 ) + w ( ZE 5 ( 6 ) = C 16 ) \cdot \\ Prob ( C 16 ) \\ = 70 \% \times 30 \% + 10 \% \times 100 \% + 10 \% \times 100 \% \\ = 41 \%\end{matrix} .$$

It should be noted that the sum of the metrics μ′ is not equal to 100% in this case because the device NF3 also covers the area of interest, but is not taken into account in the computation of the metrics since it is a transfer from this device that is of interest (the metric μ′ computed for the device NF3 is actually equal to 6% so that the sum on the devices NF3, NF4 and NF6 is indeed equal to 100%).

The selection module 9D of the device NF3 then selects the candidate device NFCm0 optimizing the metric μ′ as a potential relay for carrying out the predictions/statistics requested by the device NF2 (step H50), in other words, in the embodiment described herein, the one that maximizes the metric μ′. In the illustrative example contemplated herein, it is the device NF4 that is selected as a potential relay, in other words as a target device towards which the transfer should be initiated.

Following this selection, if the transfer is confirmed (for example, the device NF3 detects that the UE 10 exits its service area and enters the cell C8, in accordance with the completed predictions), the device NF3 uses its transfer module 9E to transfer the subscriptions it was sent by the device NF2 to the device NF4 so that it takes over these subscriptions (step H60). The device NF4 then takes over the subscriptions, collects the data from the network and carries out the corresponding statistical predictions/analyses on completion of the transfer.

It should be noted that in the end it is possible for the transfer to the device NF4 to be cancelled for various reasons. For example, if the mobility of the UE 10 was the reason behind such a transfer and the UE 10 stops moving and remains in the cell C7, such a transfer can prove to be unnecessary and can be cancelled by the device NF3. Similarly, if the UE 10 moves to the cells C11 or C12, a transfer to the NF4 device is no longer relevant. Depending on the context, if a transfer is still necessary, the device NF3 can once again ask the device NRF1 to identify another relay device for this transfer.

Furthermore, as mentioned above, it is possible, upstream of the transfer, to initiate a transfer preparation phase, during which the candidate device identified as a relay (for example, the device NF4 in the illustrative example contemplated above) for the source device begins to collect data in order to be effective as soon as the transfer is made in order to carry out the statistical analyses/predictions corresponding to the subscriptions that have been transferred thereto. The invention advantageously allows the time of initiation of this preparation phase to be determined by using the weights provided by the device NF1.

More specifically, various criteria can be examined by the transfer module 9E of the device NF3 to determine whether or not it initiates the preparation phase for preparing the transfer to the device NF4, For example, the transfer module 9E of the device NF3 initiates the preparation phase when it detects that the UE 10 that is attached thereto enters an elementary area that is covered by its service area Z3 (and by the service area of the device NF4 selected for the transfer) and to which a weight is assigned, for the service area Z3, that is lower than a given threshold. In order to avoid unintentionally initiating the preparation phase, a threshold that is strictly less than 50%, for example, 30%, is selected in this case. In the example of FIG. 7, the preparation phase is thus typically initiated when the UE 10 enters the cell C7 of the service area Z3 of the device NF3 that is assigned a weight of 20%, less than the threshold of 30%. It is also possible to consider a hysteresis and to initiate the preparation phase only when, on the one hand, the weight assigned to the elementary area entered by the UE 10 is less than a given threshold and, on the other hand, the difference between said threshold and the weight assigned to the elementary area entered by the UE 10 exceeds a certain value.

According to another example, the transfer module 9E of the device NF3 initiates the preparation phase when it detects that the UE 10 enters an elementary area that is covered by its service area Z3 (and by the service area of the device NF4 selected for the transfer) and to which a weight is assigned, for the service area Z3, that is less than the weight assigned to said elementary area for another device implementing the NWDAF network function (i.e., the same network function as the source NF3 device). In the example of FIG. 7, this is the case, for example, when the UE 10 enters the cells C3, C5, C7 or C10, though with only C3 and C7 being covered by the device NF4 and being relevant for a transfer to the device NF4.

If the criterion examined by the transfer module 9E is confirmed, said transfer module initiates the preparation phase for preparing the transfer to the target device selected during step H50 in a manner per se known (device NF4 in the contemplated illustrative example), as is notably described in document TS 23.288, paragraph 6.1B2.2.

The invention has been described above with reference to a 5G core network, and to NWDAF, AMF and NRF network functions. However, the invention can be applied in other contexts, to other networks, as well as to other network functions whenever a selection is necessary between several devices implementing the same network function and having overlapping service areas.

Although the present disclosure has been described with reference to one or more examples, workers skilled in the art will recognize that changes may be made in form and detail without departing from the scope of the disclosure and/or the appended claims.

1. A delivery method implemented by a delivery entity of a communication network, the method comprising:
delivering information relating to a first device of the communication network, said first device hosting a network function implementing at least one functionality in said network in a service area covering an integer number, greater than one, of areas, called elementary areas, each elementary area corresponding to a cell of said network or to a location area defined for said network, said delivering comprising:
acquiring, for at least one elementary area covered by said service area of the first device, a weight assigned to this elementary area, with said weight being a real number greater than or equal to 0; and
delivering all or some of said weights acquired during the acquisition step to a second device of the network.

2. The delivery method as claimed in claim 1, wherein said second device is configured to manage devices hosting network functions and all or some of said acquired weights are delivered to the second device when registering or updating a profile of the first device at the second device.

3. The delivery method as claimed in claim 1 wherein the delivery entity is implemented by the first device, wherein said first device hosts a network function of collecting and analyzing network data.

4. The delivery method as claimed in claim 1, wherein the acquired weights assigned to the elementary areas covered by said service area are acquired when registering a profile of the first device and all or some of said acquired weights are delivered in response to a discovery request for discovering network devices hosting a network function and meeting at least one given search criterion, with said discovery request originating from the second device and said first device meeting said at least one given search criterion.

5. The delivery method as claimed in claim 1, wherein the weight assigned to one of said elementary areas depends on a distance from this elementary area to a center of the service area and/or its distance relative to a border of said service area,

6. The delivery method as claimed in claim 1, wherein, when one of said elementary areas is covered by the service area of the first device and at least one other service area of at least one third device of the network hosting the same network function as said first device:
a different weight is assigned to said elementary area for the service area of the first device and for said at least one other service area of said at least one third device; and/or
a sum of the weights assigned to said elementary area for said service area of the first device and for said at least one other service area of said at least one third device is non-zero and less than or equal to 1.

7. The delivery method as claimed in claim 1, comprising:
updating at least one weight assigned to an elementary area covered by said service area; and
delivering said at least one updated weight to the second device,

8. A selection method for selection, by a first device of a communication network, comprising:
sending to a second device of the network a discovery request for discovering network devices hosting a network function and meeting at least one given search criterion;
acquiring a response to said discovery request identifying at least one network device, called candidate device, hosting a network function and meeting said at least one given search criterion, with said response comprising, for each candidate device with a service area covering an area of interest defined by the first device, said service area covering an integer number, greater than one, of areas, called elementary areas, each elementary area corresponding to a cell of said network or to a location area defined for said network, a weight assigned to each elementary area covered by said service area and said area of interest, said weight being a real number greater than or equal to 0; and
selecting one of said candidate devices in order to implement at least one functionality of the network function that the selected candidate device hosts by comparing the weights assigned to the elementary areas covered by said area of interest acquired for each candidate device identified in the response.

9. The selection method as claimed in claim 8, wherein the selecting comprises determining, for each candidate device of the network identified in the response, a metric based on the acquired weights assigned to the elementary areas covered by the service area of this candidate device and by the area of interest, with the selected candidate device being the candidate device that optimizes said metric from among the candidate devices identified in the response.

10. The selection method as claimed in claim 9, wherein the metric determined for one of said candidate devices is a weighted sum of the weights assigned to the elementary areas covered by the service area of this candidate device and by the area of interest.

11. The selection method as claimed in claim 10, wherein, in the weighted sum, each weight assigned to an elementary area is weighted by a probability of the presence of a user equipment managed by the first device in this elementary area.

12. The selection method as claimed in claim 8, wherein the first device and said selected candidate device host the same network function, and said selected candidate device is used as a relay of the first device to implement at least one functionality of said network function.

13. The selection method as claimed in claim 12, further comprising, when the first device detects entry of a user equipment that the first device manages into an elementary area covered by a service area of the first device, and having an assigned weight for the first device that is less than a given threshold or is less than a weight assigned to said elementary area for one of said candidate devices identified in the response to the discovery request, initiating a phase of preparing a use of the selected candidate device as a relay of the first device.

14. The selection method as claimed in claim 1, wherein said network is a cellular network and each elementary area comprises at least one cell of the cellular network.

15. A delivery entity of a communication network, comprising:
at least one processor; and
at least one non-transitory computer readable medium comprising instructions stored thereon which when executed by the at least one processor configured the delivery entity to deliver information related to a first device of said network, with said first device hosting a network function implementing at least one functionality in said network in a service area covering an integer number, greater than one, of areas, called elementary areas, each elementary area corresponding to a cell of said network or to a location area defined for said network, the delivering comprising:
acquiring, for at least one elementary area covered by the service area of the first device, a weight assigned to this elementary area, with said weight being a real number greater than or equal to 0; and
delivering all or some of the weights acquired by the acquisition module to a second network device.

16. A selection entity of a communication network, comprising:
at least one processor; and
at least one non-transitory computer readable medium comprising instructions stored thereon which when executed by the at least one processor configure the selection entity to:
send to a network device a discovery request for discovering network devices hosting a network function and meeting at least one given search criterion;
acquire a response to said discovery request identifying at least one network device, called candidate device, hosting a network function and meeting said at least one given search criterion, with said response comprising, for each candidate device with a service area covering an area of interest defined by the selection entity, said service area covering an integer number, greater than one, of areas, called elementary areas, each elementary area corresponding to a cell of said network or to a location area defined for said network, a weight assigned to each elementary area covered by said service area and said area of interest, said weight being a real number greater than or equal to 0; and
select one of said candidate devices in order to implement at least one functionality of the network function that the selected candidate device hosts, by comparing the weights assigned to the elementary areas covered by said area of interest that are acquired for each candidate device identified in the response.

17. (canceled)

18. (canceled)

19. The selection method as claimed in claim 8, wherein said network is a cellular network and each elementary area comprises at least one cell of the cellular network.
